(19) United States
(12) Patent Application Publication
(10) Pub. No.: US 2012/0317728 A1
(43) Pub. Date: Dec. 20, 2012

(54) SOFT LOCK WIRE TWISTING PLIERS

(75) Inventor: Ronald J. Geibel, Schaumburg, IL (US)

(73) Assignee: Stride Tool, Inc.

(21) Appl. No.: 13/495,341

(22) Filed: Jun. 13, 2012

Related U.S. Application Data
(60) Provisional application No. 61/520,707, filed on Jun. 14, 2011.
(60) Provisional application No. 61/606,597, filed on Mar. 5, 2012.

(51) Int. Cl. B25B 7/22

(52) U.S. Cl. 7/127

(57) ABSTRACT

A plier having a wire twisting mechanism mounted on one handle with the opposing handle providing a multi tooth lock bar. A slide lock which actuates a spring retractable lock pawl is mounted on the twisting mechanism support. This arrangement allows locking of the plier handles when the proper jaw pressure is applied to varying thickness' of safety wire or any other item held in the pliers grip. A squeeze of the handles retracts the law pawl and releases the pliers grip.

### RELATED APPLICATIONS

This application claims the benefit of the earlier filing dates of U.S. Provisional Patent Application No. 61/520,707 filed Jun. 14, 2011 and U.S. Provisional Patent Application No. 61/606,597 filed Mar. 5, 2012. The disclosures in aforementioned U.S. Provisional Patent Applications Nos. 61/520,707 and 61/606,597 are hereby incorporated herein in their entirety by this reference thereto.

### FIELD OF THE INVENTION

The present invention relates to a plier-type hand tool for twisting safety wire.

### BACKGROUND OF THE INVENTION

There are many prior patents related to wire twisting pliers some single direction twist pliers, and some reversible pliers that twist wire in a right or left direction. These prior patents lock the wire in the plier jaw with a single lock position. In U.S. Pat. No. 5,211,209 Geibel; a single lock position is shown. Wire twist pliers twist a variety of wire sizes depending on the job requirements. The most common sizes are 0.012″, 0.020″, 0.025″, 0.032″, 0.041″, and 0.051″. The prior art single lock position wire twist pliers work well with the smaller wire sizes. However, as the wire size increases, excessive jaw pressure is placed on the wire in order to lock the handles, making the handles difficult to lock and causing damage to the safety wire. This damage to the wire can cause premature failure of the safety wire in its application.

### SUMMARY OF THE INVENTION

This invention relates to plier-type hand tools, particularly to plier-type hand tools adapted to twist safety wire of various diameters. A multi-tooth soft lock mechanism allows the user of either a single direction wire twist plier or a reversible wire twist plier to place the exact amount of pressure desired to secure various wire sizes in the plier jaw for twisting. Digital intervention locks the handles together, retaining the grip. A squeeze of the handles automatically releases the wire.

### BRIEF DESCRIPTION OF THE DRAWINGS

The foregoing and other features of the invention will become more apparent upon a consideration of the following description taken in connection with the accompanying drawings wherein:

FIG. 1 depicts a plan view of the soft lock wire twisting pliers 100 of this invention shown with the handles in the unlocked position;

FIG. 1a depicts a plan view of the soft lock wire twisting pliers 100 of this invention shown with the handles in the locked position;

FIG. 2 depicts an exploded view of the soft lock wire twisting pliers 100 of this invention with the lock pawl 130 removed;

FIG. 2a depicts an end view of the twisting mechanism support 118 showing the lock bar guide 122, lock pawl pivot hole 132 and lock pawl control pin slot 134;

FIG. 2b depicts a side view of the twisting mechanism support 118 showing the lock bar guide 122, lock pawl pivot hole 132 and lock pawl control pin slot 134;

FIG. 3 depicts an exploded view of soft lock twisting pliers 100 of this invention showing the control arm release spring 138 and the actuating sleeve control arm 136;

FIG. 4 depicts a perspective view of slide lock 146 three views of louvered finger grip 142 slide lock arm 136 opening in slide lock arm 140 which receives lock pawl control pin 128 and spring contact point 144;

FIG. 5 depicts a cut away view from the jaw end of pliers showing the twisting mechanism support 118, lock bar 120, pawl 130, and slide lock arm 136;

FIG. 6 is a fragmentary schematic illustration, depicting the manner in which the soft lock wire twisting pliers 100 are utilized to grip end portions of one or more wires having relatively small diameters;

FIG. 7 is a fragmentary schematic illustration, generally similar to FIG. 6, depicting the manner in which the soft lock wire twisting pliers 100 are utilized to grip end portions of one or more wires having a diameter which is larger than the diameter of the wire end portions illustrated in FIG. 6; and

FIG. 8 is a fragmentary schematic illustration, depicting the manner in which the soft lock wire twisting pliers 100 are utilized to grip end portions of one or more wires having diameters which are greater than the diameter of the wire end portions of FIG. 7.

### DETAILED DESCRIPTION OF THE INVENTION

A soft lock wire twist plier is provided, which includes a pair of plier arms, each having a jaw portion with a grip/cutting area, and a handle portion pivotally interconnected and movable between an open position and a closed position. Either a single direction or reversible rotating means is mounted on one of the arms. A slide lock consisting of a louvered finger grip, slide lock arm, lock pawl and slide lock release spring are also positioned on the rotating means. The opposing plier arm supports a multi-tooth lock bar. When the desired holding pressure is placed on the safety wire in the plier jaws, the actuating sleeve is activated against spring pressure to move the pawl teeth into the lock bar teeth. The pressure is then reduced on the handles. The resulting tension keeps the pawl engaged in the lock bar. This holds the precise amount of pressure on the wire for twisting. The more the handles attempt to move outward, the tighter the pawls teeth pull into the lock bar. To release the wire, a squeeze of the handles allows the spring-loaded slide lock to release the lock pawl and hold it clear of the lock bar.

The soft lock system also allows the plier to have many other uses other than twisting wire since the jaws may be locked in numerous positions. For example, the tool can be locked onto a washer so the washer can be placed over a screw in a confined area or the tool can be used as a clamp to hold items of varying thickness.

The lock pawl is described as preferably having one to four teeth. More preferably two to four teeth. Most preferably two to three teeth. The lock bar is described as preferably having two to twelve teeth. More preferably having four to ten teeth. Most preferably having seven to nine teeth.

The lock pawl's movement is limited by the elongated slot in the twisting mechanism which receives the lock pawl control pin. The pawl control pin also secures the slide lock arm in place. The pawl is held in place by flaring the end of the pawl pivot pin or by placing a retaining clip in a groove in the lock pawl pivot pin.

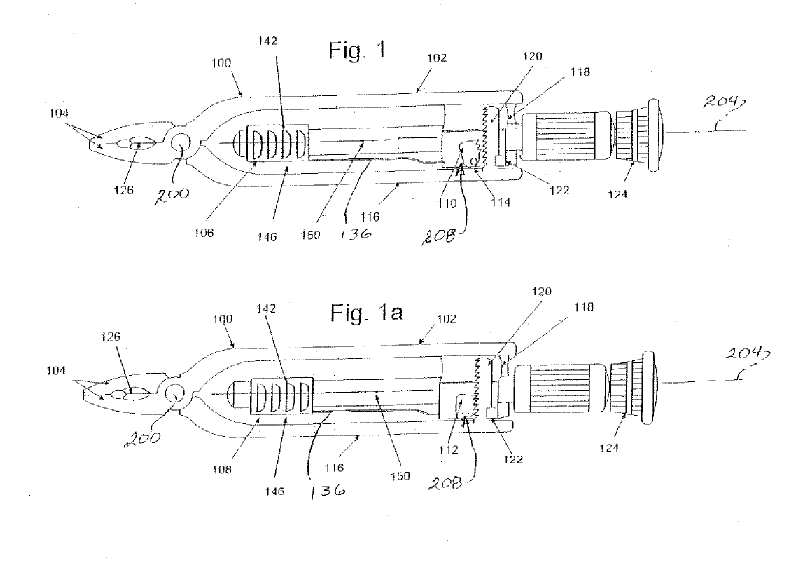

A soft lock wire twisting plier or tool 100 constructed in accordance with the present invention is illustrated in FIGS. 1 and 1a. The tool 100 includes plier jaws or clamp members 104 which are connected with plier arms or handles 102 and 116. The manually engagable plier arms or handles 102 and 116 extend from a pivot joint 200 in a direction away from the plier jaws or clamp members 104. Each of the plier arms or handles 102 or 116 is integrally formed as one piece with one of the plier jaws or clamp members 104.

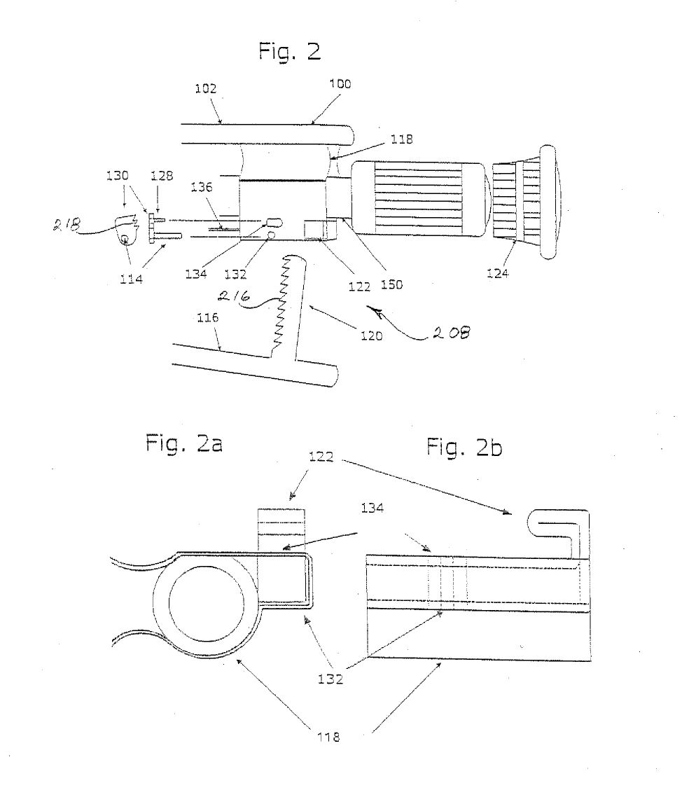

A known twisting mechanism 150 is disposed between the plier arms or handles 102 and 116. The twisting mechanism 150 is fixedly secured to one of the plier arms, i.e., the plier arm 102. A twisting mechanism support 118 (FIG. 2) fixedly connects the twisting mechanism 150 to the plier arm 102. Therefore, the twisting mechanism 150 moves with the plier arm 102 relative to the plier arm 116 during relative movement between the plier arms 102 and 116 to move the plier jaws 104 relative to each other.

The twisting mechanism 150 (FIGS. 1 and 2) has the same construction as is disclosed in U.S. Pat. No. 5,560,402. However, it is contemplated that the twisting mechanism may have a different construction. For example, the twisting mechanism 150 may have the construction as is disclosed in U.S. Pat. No. 5,211,209.

The twisting mechanism support 118 connects the plier arm or handle 102 with the twisting mechanism 150. The twisting mechanism 150 is disposed between the two plier arms or handles 102 and 116. The path of movement of the plier arm or handle 116 relative to the plier arm or handle 102 during pivotal movement of the plier arm or handle 116 about the pivot joint 200, extends through the twisting mechanism 150.

A central axis 204 (FIG. 1) of the twisting mechanism 150 extends through the pivot joint 200 and intersects a central axis of the pivot joint. The central axis 204 of the twisting mechanism 150 is disposed in a plane containing the central axes of the plier arms or handles 102 and 116. The plane containing the central axes of the plier arms 102 and 116 and the twisting mechanism 150 extends perpendicular to the central axis of the pivot joint 200.

The tool 100 has a general construction and mode of operation which is similar to the general construction and mode of operation of the wire twisting tools disclosed in U.S. Pat. Nos. 4,842,025; 5,211,209; and 5,560,402. The disclosures in the aforementioned U.S. Pat. Nos. 4,842,025; 5,211,209; and 5,560,402 are hereby incorporated herein in their entirety by reference.

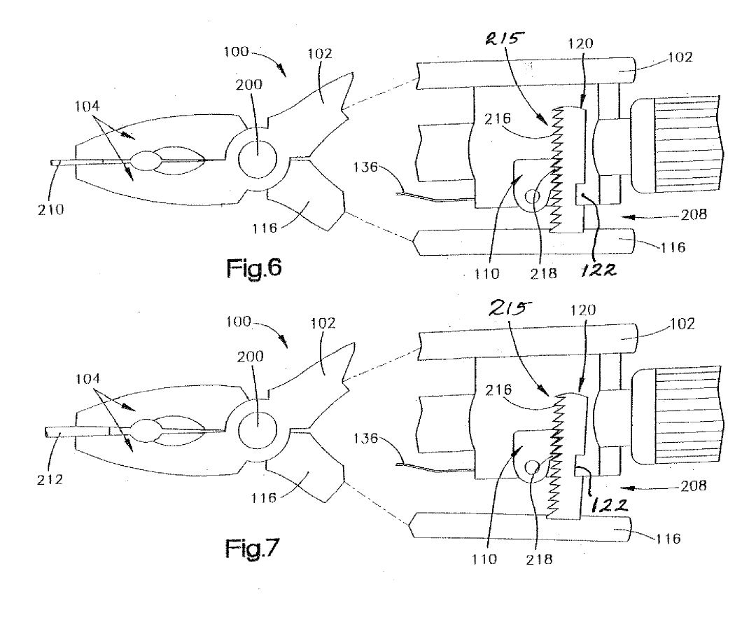

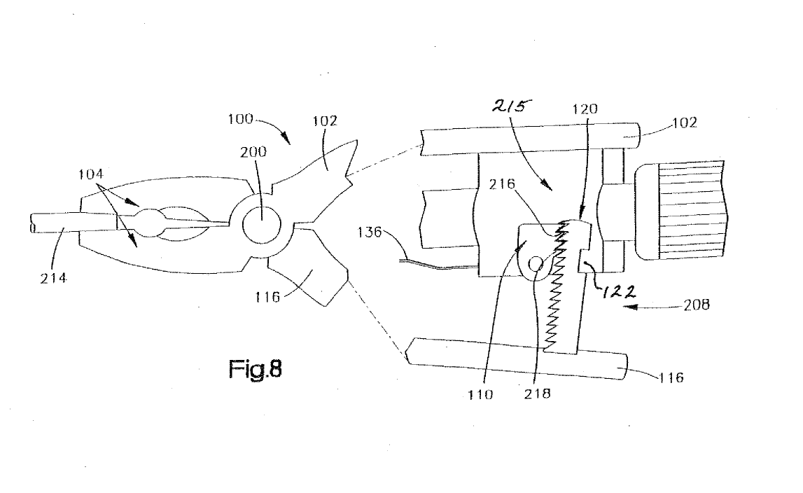

In accordance with one of the features of the present invention, a retainer mechanism 208 (FIGS. 1-5) is provided to retain the plier jaws or clamp members 104 in any one of a plurality of positions, as a function of the thickness of one or more wires which are gripped by the plier jaws. The manner in which the retainer mechanism 208 holds the plier jaws or clamp members 104 in gripping engagement with a relatively thin wire 210 is illustrated schematically in FIG. 6. The manner in which the retainer mechanism 208 holds the plier jaws or clamp members 104 in gripping engagement with a wire 212 having a thickness which is greater than the thickness of the wire 210, is illustrated schematically in FIG. 7. The manner in which the retainer mechanism 208 holds the plier jaws or clamp members 104 in gripping engagement with a wire 214 having a thickness which is greater than the thickness of the wire 212, is illustrated schematically in FIG. 8.

It should be understood that although only a single wire 210 has been illustrated in FIG. 6, it is contemplated that the plier jaws or clamp members 104 may engage portions of one or more wires. For example, opposite end portions 210 of a single relatively thin wire may be gripped by the plier jaws or clamp members 104. Alternatively, end portions 210 of two separate wires may be gripped by the plier jaws or clamp members 104. Similarly, two end portions of one or more wires 212 or 214 may be gripped by the plier jaws or clamp members 104 in the manner illustrated schematically in FIGS. 7 and 8.

While two end portions of one or more wires 210, or 212, or 214 are gripped by the plier jaws or clamp members 104 in the manner illustrated schematically in FIG. 6, or 7, or 8, the twisting mechanism 150 is manually operated to twist the wire or wires in the manner disclosed in U.S. Pat. No. 4,665,953. The disclosure in the aforementioned U.S. Pat. No. 4,665,953 is hereby incorporated herein in its entirety by reference.

The retainer mechanism 208 includes a lock pawl or retainer member 110 (FIG. 1) which is engageable with a series 215 (FIGS. 6-8) of retaining or locking teeth or locations 216. The series of retaining or locking locations 216 are formed in a lock bar 120 which is fixedly connected with the plier arm or handle 116. The series 215 of locking locations 216 are disposed in a linear array along one side of the lock bar 120. Each of the retaining or locking locations 216 in the series 215 of locking locations is formed by one of a plurality of teeth formed in the lock bar 120 (FIGS. 6-8).

When the plier jaws or clamp members 104 engage the relatively thin wire 210 (FIG. 6), the plier arm or handle 116 is displaced a relatively small distance downward (as viewed in FIG. 6) from the plier arm or handle 102. The teeth 218 on the lock pawl 110 engage teeth 216 in the series 215 of teeth on the lock bar. The lock bar teeth 216 engaged by the lock pawl teeth 218 are relatively close to the lower (as viewed in FIG. 6) end portion of the lock bar 112. Although the lock pawl or retainer member 110 has a plurality of teeth 218, it is contemplated that the lock pawl may have a single tooth.

When the plier jaws or clamp members 104 are to grip the relatively thin wire end portions 210, the lock pawl 110 is moved to a disengaged condition (FIG. 1) in which it is spaced from the series 214 of locking teeth 216. The plier arms or handles 102 and 116 are then moved away from each other and the jaws 104 are moved to an open condition. The open plier jaws or clamp members 104 are positioned adjacent to opposite sides of the thin wire portions 210.

Pressure is then manually applied against the plier arms or handles 102 and 116 to close the plier jaws or clamp members 104 against opposite sides of the relatively thin wire end portions 210 (FIG. 6). The manual force which is applied against the handles 102 and 116 is effective to resiliently deflect the handles through a short distance toward each other. The lock pawl 110 is then pivoted in a clockwise direction (as viewed in FIGS. 1 and 6) about the pivot pin 114 (FIGS. 1, 3, and 5). This moves the teeth 218 (FIG. 6) on the lock pawl 110 into engagement with teeth 216 on the lock bar 120 at a location relatively close to the lower end portion of the lock bar 120. The teeth 218 on the lock pawl 110 engage teeth 216 which are relatively close to the lower end portion (as viewed in FIG. 6) of the lock bar 120 because the plier arms or handles 102 and 116 have been manually squeezed together to cause the plier jaws or clamp members 104 to firmly grip the relatively thin wire end portions 210.

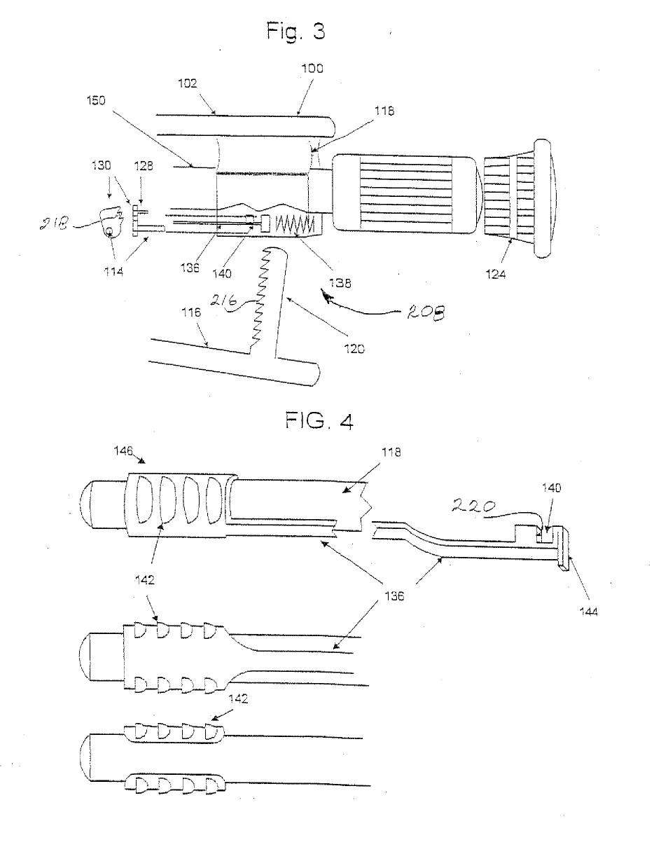

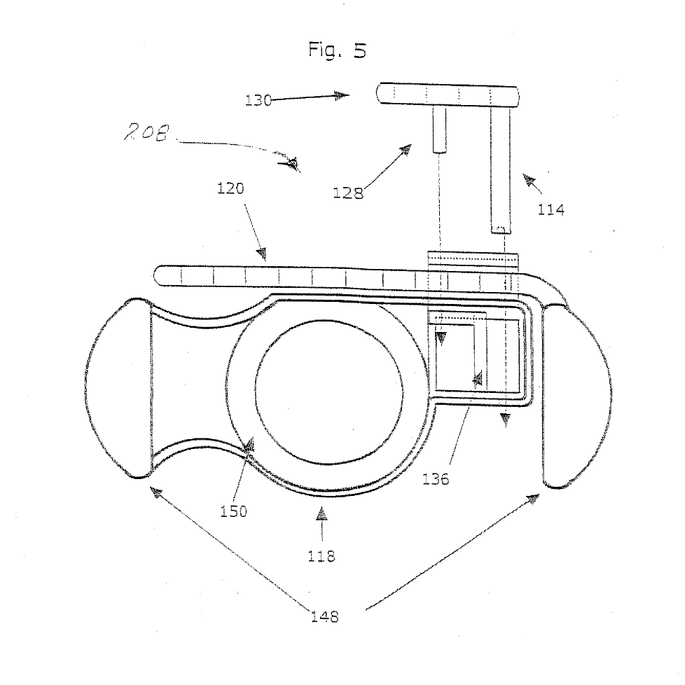

To pivot the lock pawl in a clockwise direction from the disengaged position of FIG. 1 to the engaged position of FIGS. 1a and 6, a finger grip 142 on the slide lock 146 is manually moved toward the right (as viewed in FIG. 1) along the twisting mechanism 150. As this occurs, the slide lock control arm 136 (FIG. 4) is moved toward right, as viewed in FIGS. 3 and 4. Manual force is transmitted from the slide lock 140 through the slide lock control arm 136. This force is transmitted from a left (as viewed in FIG. 4) side surface 220 of the opening 140 to the lock pawl control pin 128 (FIGS. 3 and 5). This force is effective to pivot the lock pawl 110 in a clockwise direction from the disengaged position of FIG. 1 to the engaged position of FIG. 6. As this occurs, the teeth 218 (FIG. 6) the lock pawl 110 are firmly pressed into meshing engagement with the teeth 216 on the lock bar 120.

In the illustrated embodiment of the invention, the lock pawl 110 has a plurality (e.g., three) teeth 218 (FIG. 6) which are moved into meshing engagement with the teeth 216 on the lock bar 120 under the influence of manual force transmitted through the slide lock control arm 136. However, the lock pawl 110 may have either a greater or lesser number of teeth 218. For example, the lock pawl 110 may have four or five teeth 218 if desired. As another example, the lock pawl 110 may have one or two teeth 218.

Once the teeth 218 on the lock pawl 110 have moved into meshing engagement with the teeth 216 on the lock bar 120 (FIG. 6), the plier arms or handles 102 and 116 are manually released. The natural resilience of the plier arms or handles 102 and 116 causes them to tend to spring apart. This firmly presses the teeth 216 on the lock bar 120 against teeth 218 on the lock pawl 110. The finger grip 142 (FIG. 2) on the slide lock 106 is then manually released.

At this time, the plier arms or handles 102 and 116 are still slightly deflected. The resiliently deflected plier arms or handles 102 and 116 press the teeth 116 on the lock bar 120 firmly against the teeth 218 on the lock pawl 110. This results in the lock pawl 110 being maintained in the locking or engaged condition of FIG. 6 against the influence of the force applied to the control arm 136 by the control arm release spring 138 (FIG. 3).

When the relatively thin wire portions 210 (FIG. 6) are to be released, the plier arms or handles 102 and 116 are manually pressed toward each other. This eliminates the resilient downward (as viewed in FIG. 6) force applied by the plier arms or handles 102 and 116 to the lock bar 120. As this occurs, the teeth 216 on the lock bar are moved upwardly (as viewed in FIG. 6) away from the teeth 218 on the lock pawl 110. This results in the lock pawl 110 being released for pivotal movement in a counterclockwise direction under the influence of force applied against the control arm 136 by the release spring 138 (FIG. 3). This allows the plier arms or handles 102 and 116 to move away from each other so that the plier jaws or gripper members 104 are opened and the wire portions 210 released.

In FIG. 6, the tool 100 is being utilized to grip relatively thin wire portions 210. In FIG. 7, the tool 100 is being utilized to grip wire portions 212 having a thickness (diameter) which is greater than the thickness of the wire portions 210. When the wire jaws or clamp members 104 grip the wire end portions 212 (FIG. 7), the wire jaws are separated by a greater distance than when thin wire portions 210 (FIG. 6) are gripped. This results in the plier arms or handles 102 and 116 being separated by a greater distance when relatively thick wire end portions 212 are gripped (FIG. 7) than when relatively thin wire end portions 210 (FIG. 6) are gripped.

Since the plier arms or handles 102 and 116 are separated further, the teeth 218 on the lock pawl 210 engage the teeth 216 on the lock bar 120 at a location which is displaced further from the lower (as viewed in FIG. 7) plier arm or handle 116 than when the relatively thin wire end portions 210 (FIG. 6) are gripped. This results in each tooth 218 on the lock pawl 110 engaging a different tooth on the lock bar 120 when the tool 100 is gripping relatively thick wire end portions 212 than when the tool is gripping relatively thin wire end portions 210.

In the embodiment of the invention illustrated in FIG. 8, the tool 100 is utilized to grip wire end portions 214 which are thicker, that is, have a larger diameter than the wire end portions 212 (FIG. 7). To grip the relatively thick wire end portions 214 (FIG. 8), the plier jaws 104 have to be separated by a distance which is greater than the separation between the plier jaws required to grip the wire end portions 212. This results in the plier arms or handles 102 and 116 being separated by a relatively large distance (FIG. 8) which is greater than the distance which the plier arms or handles 102 and 116 are separated when the thinner wire end portions 212 (FIG. 7) are gripped. This results in the teeth 218 on the lock pawl 110 engaging teeth 216 on the lock bar 120 at a location which is spaced further from the lower (as viewed in FIG. 8) wire arm or handle 116 than when the relatively wire end portions 212 are gripped (FIG. 7).

Due to the plier jaws or clamp members 104 being separated by different distances when wire portions 210, 212 or 214 (FIGS. 6, 7 and 8) having different thickness are gripped, the plier arms or handles 102 and 116 are separated by different distances when wire portions having different thickness are gripped. Due to the different distances between the plier arms or handles 102 and 116 when the wire portions 210, 212 or 214 having different thickness are gripped, the lock pawl teeth 218 engage different lock bar teeth 216 when wire portions having different thickness are gripped. This results in the locations where the lock pawl teeth 218 engage the lock bar teeth 216 varying as a function of the thickness of the wire portions being gripped by the plier jaws or clamp members 104.

Having described the invention, the following is claimed:

1. A tool for use in twisting wires of any one of a plurality of different thicknesses, said tool comprising a pair of clamp members which are operable between a closed condition gripping at least one wire to be twisted and an open condition in which said clamp members are ineffective to grip a wire, a retainer mechanism which is connected with said clamp members, said retainer mechanism being operable to any of a plurality of retaining conditions as function of the thickness of a wire to be twisted, said retainer mechanism including a series of retaining locations and a retainer member which engages a first one of said retaining locations when said clamp members are in the closed condition and are gripping a wire having a first thickness, said retainer member engages a second one of said retaining locations when said clamp members are in the closed condition and are gripping a wire having a second thickness which is greater than said first thickness, said retainer member engages a third one of said retaining locations when said clamp members are in the closed condition and are gripping a wire having a third thickness which is greater than said first and second thicknesses, and a manually actuatable twisting mechanism connected with said clamp members and said retainer mechanism, said twisting mechanism being manually actuatable to effect rotation of said clamp members to twist said at least one wire while said at least one wire is gripped by said clamp members.

2. A tool as set forth in claim 1 further including first and second handles having first end portions which are connected with said clamp members and second end portions which are connected with said retainer mechanism, said second end portions of said handles being spaced a first distance apart when said retainer member engages said first one of said retaining locations, said second end portions of said handles being spaced a second distance apart when said retainer member engages said second one of said retaining locations, said second distance being greater than said first distance, said second end portions said handles being spaced a third distance apart when said retainer member engages said third one of said retaining locations, said third distance being greater than said second distance.

3. A tool as set forth in claim 1 further including a manually movable actuator member connected with said retainer member, said actuator member being manually movable to pivot said retainer member from a disengaged position in which said retainer member is spaced from said retaining locations to an engaged position in which said retainer member engages at least one of said retaining locations.

4. A tool as set forth in claim 3 further including a spring connected with said actuator member to urge said actuator member toward a position in which said retainer member is in the disengaged position.
